(19) United States
(12) Patent Application Publication
(10) Pub. No.: US 2023/0302560 A1
(43) Pub. Date: Sep. 28, 2023

(54) DIE CLEANING DEVICE

(71) Applicant: Pratt Corrugated Holdings, Inc., Brookhaven, GA (US)

(72) Inventor: Francisco J. Gutierrez, Lebanon, OH (US)

(21) Appl. No.: 18/123,732

(22) Filed: Mar. 20, 2023

Related U.S. Application Data
(60) Provisional application No. 63/323,541, filed on Mar. 25, 2022.

(51) Int. Cl. B23G 5/04; B23G 9/00

(52) U.S. Cl. CPC B23G 5/04; B23G 9/009

(57) ABSTRACT

A die cleaning device includes a device body comprising a chassis; a plate assembly movably mounted to the device body and comprising a cleaning plate, the cleaning plate configured to engage a die slot of a die and dislodge excess material trapped within the die slot; a lift mechanism configured to move the cleaning plate relative to the chassis between at least a lowered position and a raised position, wherein, in the lowered position, the cleaning plate is disengaged from the die slot, and in the raised position, the cleaning plate engages the die slot; and a drive mechanism configured to laterally move the cleaning plate relative to the chassis within the die slot.

### CROSS-REFERENCE TO RELATED APPLICATIONS

The present application claims the benefit of U.S. Provisional Application No. 63/323,541, filed Mar. 25, 2022, which is hereby specifically incorporated by reference herein in its entirety.

### TECHNICAL FIELD

This disclosure relates to manufacturing dies. More specifically, this disclosure relates to cleaning device for dies.

### BACKGROUND

Dies are used in manufacturing to form materials to a desired shape and/or size. Excess material can become trapped within the die and can inhibit the performance of the die. Often, workers must get underneath the die and manually force a tool into the die to clean out the excess material, which requires significant physical strength and is potentially unsafe for the worker. Additionally, manual operation of the cleaning tool can lack precision.

### SUMMARY

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Disclosed is a die cleaning device comprising a device body; a cleaning plate mounted to the device body and configured to engage a die slot of a die; a lift mechanism configured to raise the cleaning plate into engagement with the die slot; and a drive mechanism configured to laterally move the cleaning plate within the die slot.

Additionally, disclosed is a die cleaning device comprising a body comprising a chassis;

a plate assembly movably mounted to the device body and comprising a cleaning plate, the cleaning plate configured to engage a die slot of a die and dislodge excess material trapped within the die slot; a lift mechanism configured to move the cleaning plate relative to the chassis between at least a lowered position and a raised position, wherein, in the lowered position, the cleaning plate is disengaged from the die slot, and in the raised position, the cleaning plate engages the die slot; and a drive mechanism configured to laterally move the cleaning plate relative to the chassis within the die slot.

Also disclosed is a method of cleaning a die, the method comprising aligning a cleaning plate of a plate assembly of a die cleaning device with a die slot of the die, wherein the cleaning plate is in a lowered position and disengaged from the die slot; engaging the cleaning plate with the die slot; and sliding the cleaning plate laterally within the die slot to dislodge excess material trapped within the die slot.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a front perspective view of a die cleaning device, in accordance with one aspect of the present disclosure.

FIG. 2 is a front perspective view of a cleaning plate of the die cleaning device of FIG. 1.

FIG. 3 is an end view of the die cleaning device of FIG. 1.

FIG. 4 is an end view of the die cleaning device of FIG. 1 positioned beneath a die.

FIG. 5 is an end view of a lock mechanism of the die cleaning device of FIG. 1 in an unlocked position.

FIG. 6 is an end view of the lock mechanism of FIG. 5 in a locked position.

FIG. 7 is an end perspective view of the cleaning plate of FIG. 2 aligned with the die of FIG. 4, prior to engagement with the die.

FIG. 8 is an end perspective view of the cleaning plate of FIG. 2 engaged with the die of FIG. 4.

FIG. 9 is an end perspective view of the cleaning plate of FIG. 2 engaged with the die of FIG. 4 in a lowered position.

FIG. 10 is an end perspective view of the cleaning plate of FIG. 2 engaged with the die of FIG. 4 in an intermediate position.

FIG. 11 is an end perspective view of a worker scraping excess material away from the die of FIG. 4.

FIG. 12 is an end perspective view of the cleaning plate of FIG. 2 engaged with the die of FIG. 4 in a raised position.

FIG. 13A illustrates various perspective views of the die cleaning device of FIG. 1.

FIG. 13B illustrates additional perspective views of the die cleaning device of FIG. 1.

FIG. 14 illustrates a left end view, a top view, a side view, a bottom view, and a right end view of a first chassis of a chassis of the die cleaning device, in accordance with another aspect of the present disclosure.

FIG. 15 illustrates components of the first chassis of FIG. 14.

FIG. 16 illustrates a locking mechanism mounted to the first chassis of FIG. 14.

FIG. 17 illustrates various views of the first chassis, in accordance with another aspect of the present disclosure.

FIG. 18 illustrates a left end view, a top view, a side view, a bottom view, and a right end view of the first chassis, in accordance with another example aspect of the present disclosure.

FIG. 19 illustrates components of the first chassis of FIG. 18.

FIG. 20 illustrates bottom and side views of a second chassis of the chassis, in accordance with one aspect of the present disclosure.

FIG. 21 illustrates bottom and side views of a rotary shaft and sprocket assembly mounted to the second chassis, in accordance with another aspect of the present disclosure.

FIG. 22 illustrates a left end view, a top view, a side view, a bottom view, and a right end view of the second chassis, in accordance with another aspect of the present disclosure.

FIG. 23 illustrates components of the second chassis of FIG. 22.

FIG. 24 illustrates another bottom view of the second chassis, in accordance with another aspect of the present disclosure.

FIG. 25 illustrates a top view and a side view of a drive mechanism of the die cleaning device, in accordance with another aspect of the present disclosure.

FIG. 26A illustrates various perspective view of the drive mechanism, in accordance with another aspect of the present disclosure.

FIG. 26B illustrates various components of the drive mechanism, in accordance with another aspect of the present disclosure.

FIG. 27A illustrates various views of an electrical control panel of the die cleaning device, in accordance with another aspect of the present disclosure.

FIG. 27B is an electrical schematic of the die cleaning device, in accordance with another aspect of the present disclosure.

FIG. 27C is a continuance of the electrical schematic of FIG. 27B.

FIG. 27D is an end view of the chassis with the electrical control panel mounted thereon, in accordance with another aspect of the present disclosure.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutations of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed is a die cleaning device and associated methods, systems, devices, and various apparatus. Example aspects of the die cleaning device can comprise a cleaning plate configured to engage a die. It would be understood by one of skill in the art that the die cleaning device is described in but a few exemplary embodiments among many. No particular terminology or description should be considered limiting on the disclosure or the scope of any claims issuing therefrom.

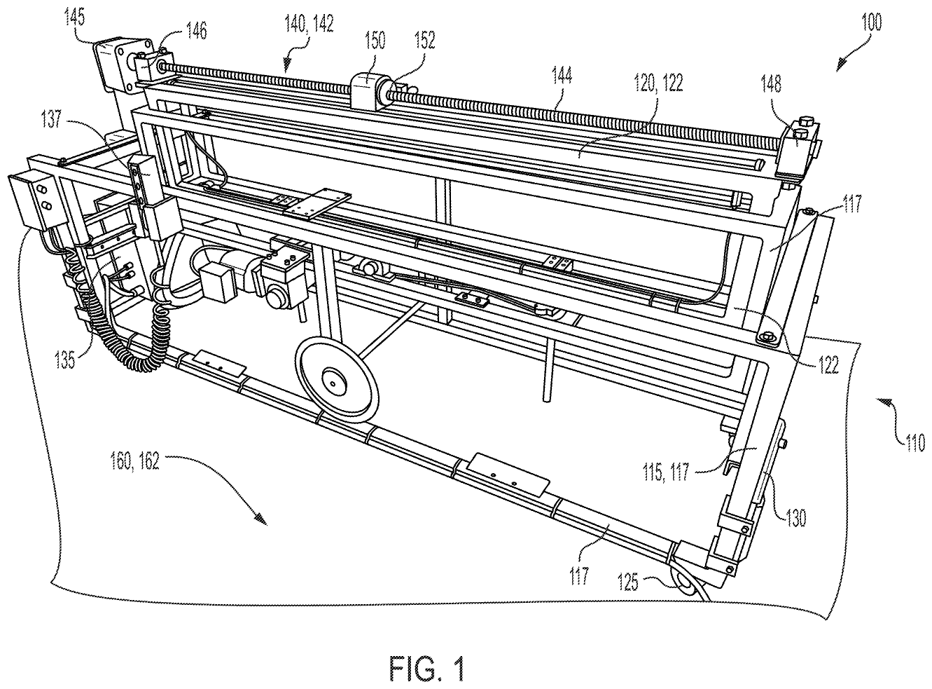

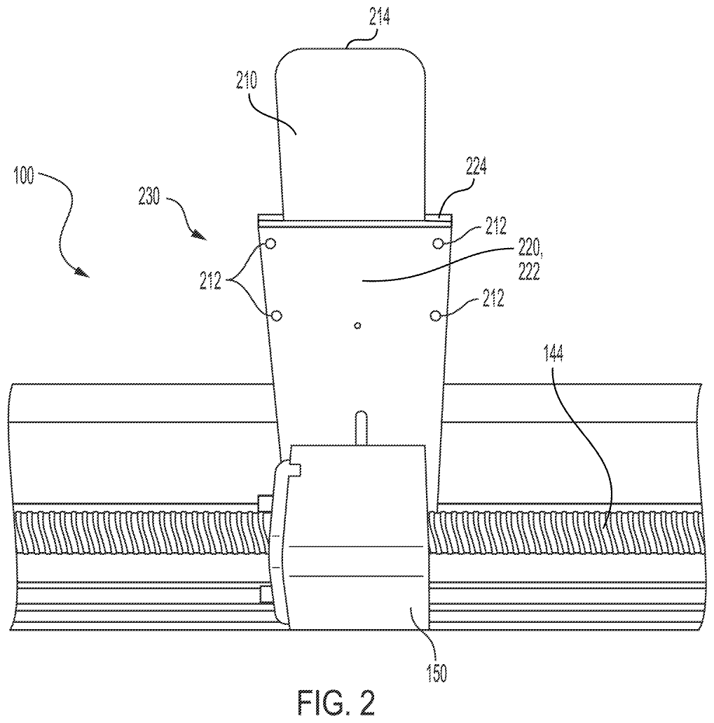

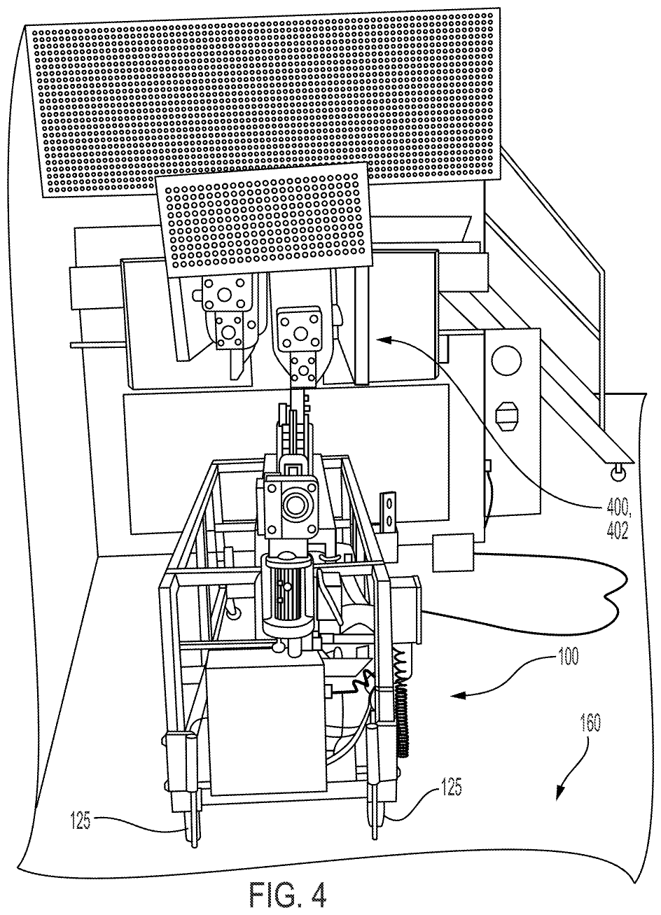

FIG. 1 is a front perspective view of a die cleaning device 100, in accordance with one aspect of the present disclosure. The die cleaning device 100 can be configured to clean excess material 1100 (shown in FIG. 11) out of a die 400 (shown in FIG. 4). According to example aspects, the die cleaning device 100 can comprise a device body 110 and a cleaning plate 210 (shown in FIG. 2). The device body 110 can comprise a chassis 115 and a lift module 120. In example aspects, the chassis 115 can comprise a first chassis frame 116 (generally, an outer chassis frame) and a second chassis frame 118 (generally, an inner chassis frame). The second chassis frame 118 can be disposed at least partially within and supported on the first chassis frame 116 in the present aspect. The chassis 115 can comprise one or more chassis frame members 117, and the lift module 120 can comprise one or more module frame members 122. The chassis 115 can be configured to support the lift module 120 above a support surface 160 (e.g. a floor 162). For example, in the present aspect, the lift module 120 can be supported on the second chassis frame 118. In some aspects, the chassis 115 can be configured to roll, slide, glide, or otherwise move along the support surface 160 to transport the die cleaning device 100 and to orient the die cleaning device 100 at a suitable position relative to the die 400 to align the cleaning plate 210 with the die 400. For example, in the present aspect, the die cleaning device 100 can comprise a plurality of wheels 125 coupled to the chassis 115, which can allow the chassis 115 to roll across the support surface 160. Furthermore, the die cleaning device 100 can comprise a locking mechanism 130 configured to lock the chassis 115 in the desired position, as described in further detail below.

The cleaning plate 210 can be mounted to the lift module 120. In the current aspect, the cleaning plate 210 can be a substantially upright, substantially planar metal paddle. In other aspects, the cleaning plate 210 can be oriented substantially horizontal or at any other suitable angle. In example aspects, the lift module 120 can be movable relative the chassis 115 between a lowered position, a raised position, and intermediate positions therebetween, thereby allowing the cleaning plate 210 to be repositionable between the lowered, raised, and intermediate positions. For example, the die cleaning device 100 can comprise a lift mechanism 135 for selectively raising and lowering the lift module 120 relative to the chassis 115. The lift mechanism 135 can be manually operated by an operator, such as with a push button control 137, as shown. In other aspects, the lift mechanism 135 can be operated by any other suitable control mechanism. In other aspects, the lift module 120 can be movable in any other suitable direction.

In example aspects, the cleaning plate 210 can further be configured to move laterally relative to the lift module 120. The die cleaning device 100 can comprise a drive mechanism 140, such as a screw drive mechanism 142, for propelling the lateral movement of the cleaning plate 210. In other aspects, the drive mechanism 140 can be any other suitable drive mechanism known in the art. The screw drive mechanism 142 can comprise an elongate threaded screw 144 rotationally mounted to the lift module 120, and can further comprise a motor 145 for driving the rotation of the screw 144. Specifically, the screw 144 can rotationally engage and extend between opposing first and second end blocks 146,148 mounted to the lift module 120, and the screw drive mechanism 142 can rotate the screw 144 at either or both of the first and second end blocks 146,148.

According to example aspects, a plate carriage 150 can be mounted on the screw 144. The plate carriage 150 can define a threaded bore 152, and the screw 144 can extend through and rotate within the threaded bore 152. As the screw 144 rotates within the threaded bore 152, the plate carriage 150 can ride along the rotating screw 144, translating laterally between the first and second end blocks 146,148 as the screw 144 rotates. The rotational direction of the screw 144 can be selectively reversed to reverse the lateral direction of the plate carriage 150. The cleaning plate 210 can be secured to the plate carriage 150, such that the cleaning plate 210 can translate laterally from side to side along with the plate carriage 150. In other aspects, the threaded bore 152 can be formed through the cleaning plate 210 or through a plate mount 220 (shown in FIG. 2) of the die cleaning device 100.

FIG. 2 illustrates a close-up view of the plate carriage 150 mounted on the screw 144. The cleaning plate 210 can be coupled to the plate carriage 150. In example aspects, the cleaning plate 210 can comprise a metal material, such as brass, for example and without limitation. In other aspects, the cleaning plate 210 can comprise any suitable material. In example aspects, the die cleaning device 100 can comprise a plate mount 220 configured to couple the cleaning plate 210 to the plate carriage 150. As shown, the plate mount 220 can be secured to and can extend substantially vertically upward from the plate carriage 150. The cleaning plate 210 can be secured to and can extend substantially vertically upward from the plate mount 220, distal to the plate carriage 150. An upper plate end 214 of the cleaning plate 210 can be a free end defined opposite the plate mount 220. The cleaning plate 210, the plate mount 220, and the plate carriage 150 can together define a plate assembly 230 configured to translate laterally along the screw 144. In some aspects, the plate mount 220 can comprise an inner mounting plate 222 and an outer mounting plate 224, and a lower end of the cleaning plate 210 can be clamped therebetween to couple the cleaning plate 210 to the plate mount 220, such as with bolts 212 or screws. In other aspects, the cleaning plate 210 can be directly coupled to the plate mount 220, such as by an adhesive.

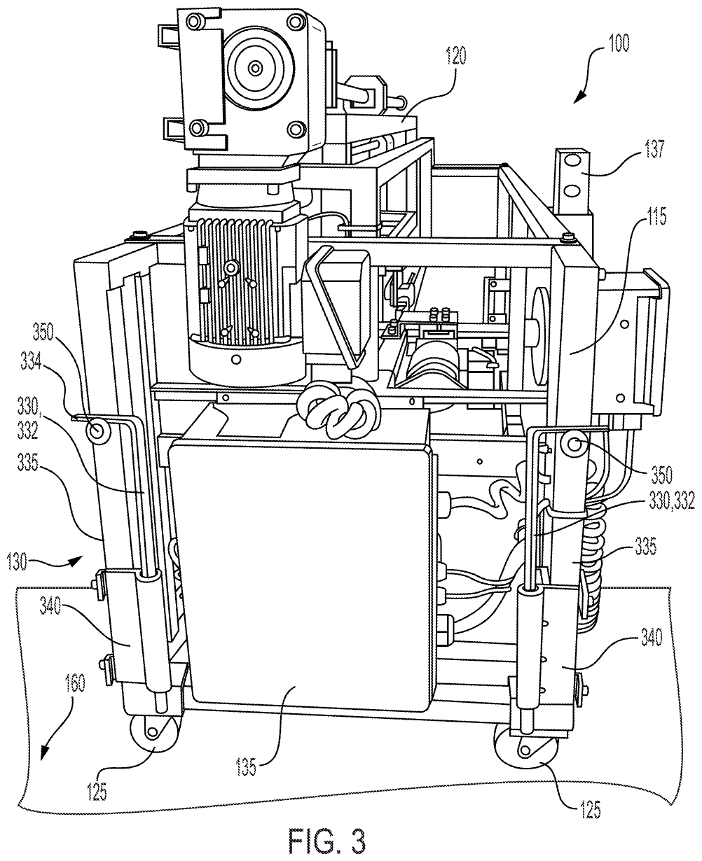

FIG. 3 illustrates an end view of the die cleaning device 100. According to example aspects, the locking mechanism 130 can comprise one or more locking members 330. For example, the locking members 330 can be locking pins 332. In the present aspect, one of the locking pins 332 can be arranged at each corner 335 of the chassis 115 and can be secured to the chassis 115 by a pin bracket 340. In other aspects, the locking pins 332 can be arranged elsewhere on the chassis 115. As shown in the present view, each of the locking pins 332 can be retained in an unlocked position, wherein the locking pin 332 is elevated above and disengaged from the support surface 160, by a pin retainer 350 secured to the chassis 115. Specifically, a handle portion 334 of each locking pin 332 can be supported on the corresponding pin retainer 350 in the unlocked position. In other aspects, the locking pin 332 can be secured in the unlocked position by any other suitable retaining methods. For example, in another aspect, the handle portion 334 of each locking pin 332 can engage a corresponding retaining groove formed in the chassis 115 to retain the locking pin 332 in the unlocked position. In other aspects, the locking mechanism 130 can comprise one or more wheel brakes or any other suitable mechanism known in the art for arresting the movement of the die cleaning device 100.

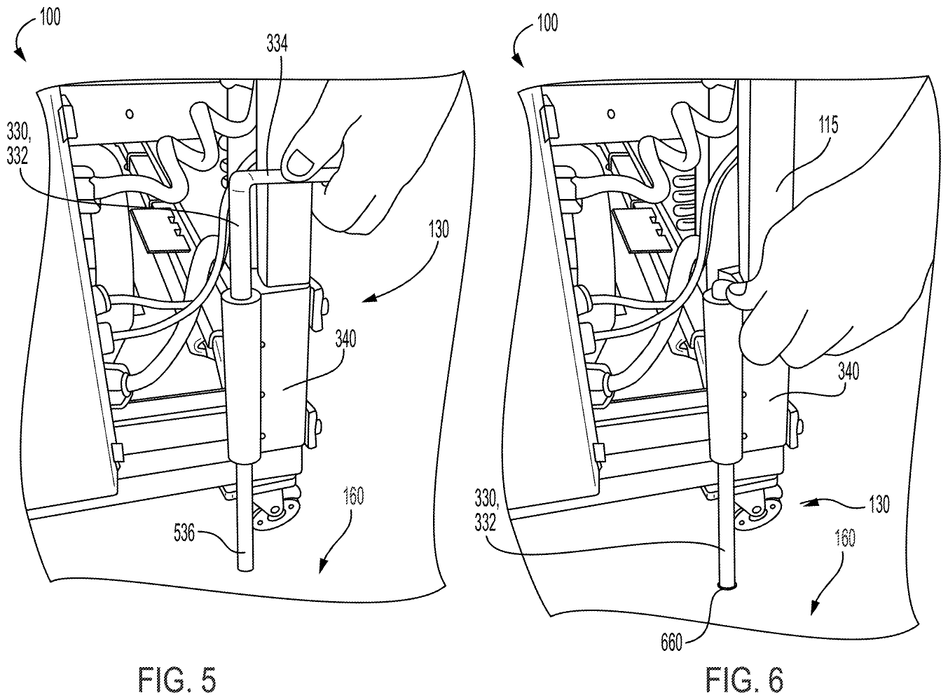

FIG. 4 illustrates the die cleaning device 100 positioned beneath the die 400. The die cleaning device 100 can be moved into position beneath the die 400 by rolling the die cleaning device 100 across the support surface 160 on the wheels 125. In the present aspect, the die 400 can be a bubble wrap-forming die 402. In other aspects, the die 400 can be any other suitable type of die utilized in the manufacturing of goods. Referring to FIG. 5, to secure the die cleaning device 100 in position beneath the die 400 (shown in FIG. 4), each of the locking pins 332 can be manually disengaged from the corresponding pin retainer 350 (shown in FIG. 3), such as by lifting the locking pin 332, rotating the locking pin 332 away from the pin retainer 350, and sliding the locking pin 332 downward through the pin bracket 340 towards the support surface 160. The locking pin 332 can define a lower pin end 536. As shown in FIG. 6, the lower pin end 536 (shown in FIG. 5) of the locking pin 332 can engage a locking hole 660 formed in the support surface 160 to position the locking pin 332 in the locked position and to secure the chassis 115 in place beneath the die 400 (shown in FIG. 4).

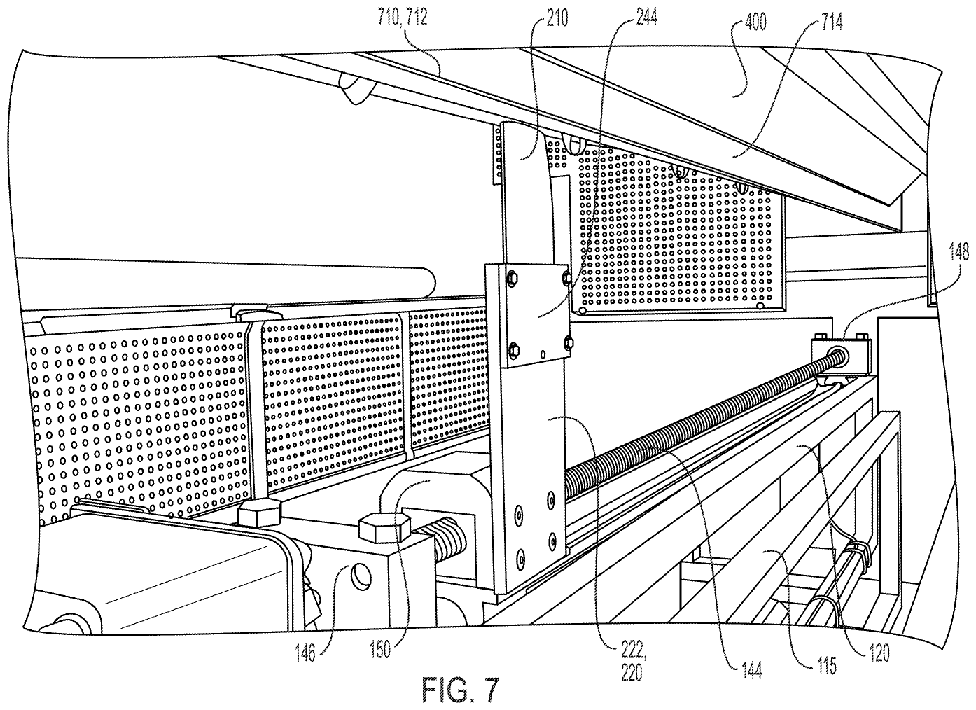

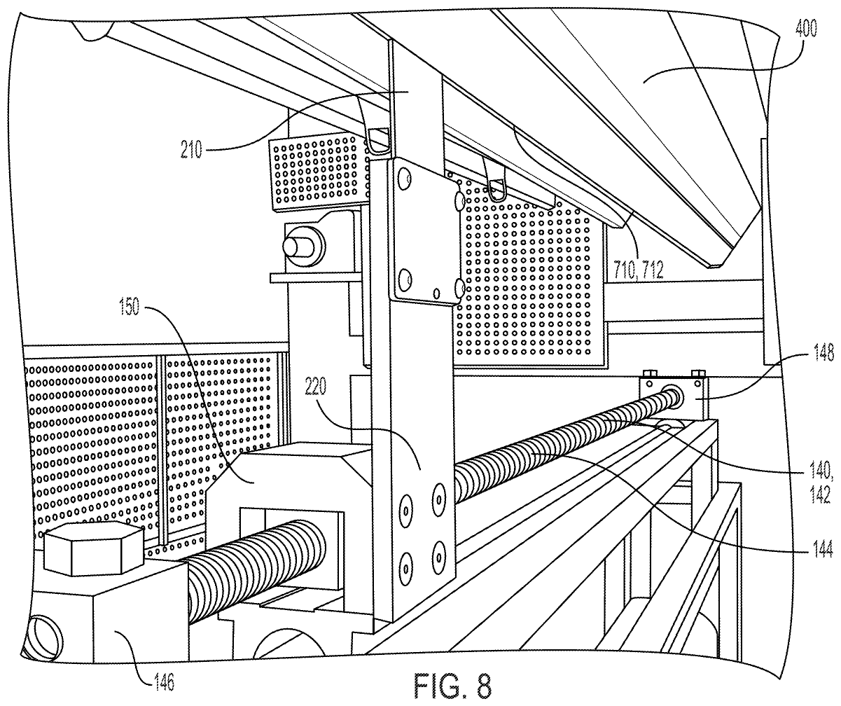

FIG. 7 illustrates the cleaning plate 210 aligned beneath a die slot 710 of the die 400, wherein the cleaning plate 210 is in the lowered position. The die slot 710 extends substantially vertically into the die 400 at a bottom die end 714 thereof. In other aspects, the die slot 710 can be a substantially horizontal die slot or can be oriented at any suitable angle. Moreover, in other aspects, the die slot 710 can be disposed at any suitable location on the die 400. According to example aspects, the lift module 120 and the cleaning plate 210 can be raised upward by the lift mechanism 135 (shown in FIG. 1) to engage the cleaning plate 210 with the die slot 710 of the die 400. The cleaning plate 210 can be configured to engage the die slot 710 at the bottom die end 714 through a slot opening 712 of the die slot 710. FIG. 8 shows the free upper plate end 214 (shown in FIG. 2) of the cleaning plate 210 engaged with the die slot 710. In example aspects, the cleaning plate 210 can initially be raised to a first intermediate position, wherein only a portion of the cleaning plate 210 engages the die slot 710. For example, in the first intermediate position, a first segment of the cleaning plate 210 between about ½ inch to 1 inch (including the free upper plate end 214) can be inserted into the die slot 710. In other aspects, a shorter or longer segment of the cleaning plate 210 can be inserted into the die slot 710 in the first intermediate position.

Once inserted into the die slot 710, the screw drive mechanism 142 can slide or otherwise move the cleaning plate 210 laterally within the die slot 710. As the cleaning plate 210 moves, the cleaning plate 210 can dislodge excess material 1100 (shown in FIG. 11) trapped within the die slot 710 and can push the excess material 1100 out of the die slot 710 through the slot opening 712. In example aspects, the cleaning plate 210 can be moved within the die slot 710 in a first lateral pass substantially from the first end block 146 to the second end block 148. At the second end block 148, the cleaning plate 210 can be raised by the lift mechanism to a second intermediate position, wherein an additional second segment (e.g., between about an additional ½ inch to 1 inch) of the cleaning plate 210 can be inserted into the die slot 710, although the distance the cleaning plate 210 is raised can be outside this range in other aspects, as desired. The cleaning plate 210 can then be moved within the die slot 710 in a second lateral pass substantially from the second end block 148 to the first end block 146. In other aspects, the cleaning plate 210 can undergo multiple passes before raising the cleaning plate 210 to the next position.

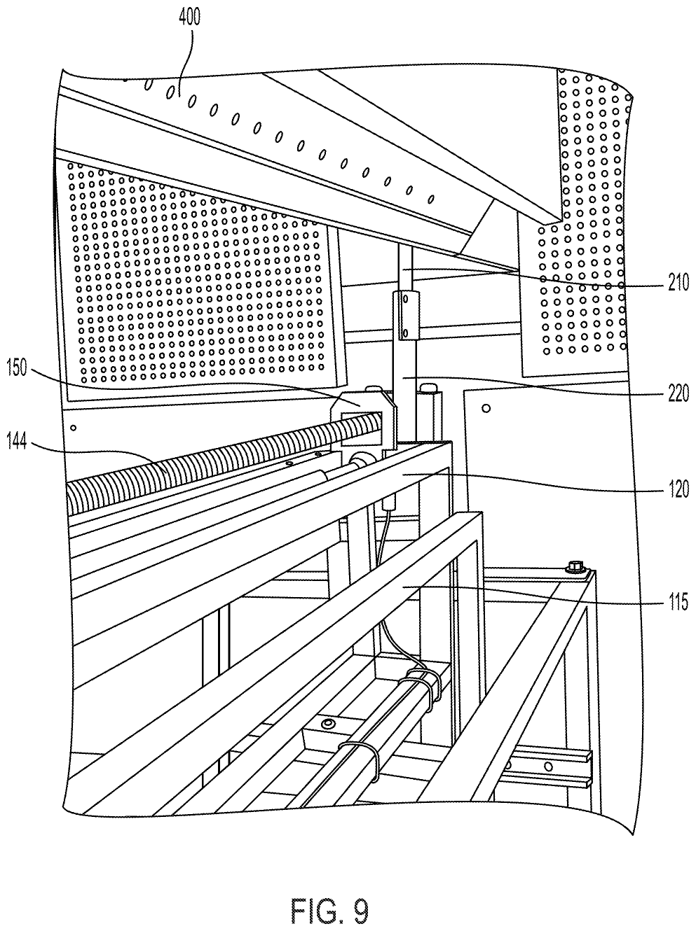

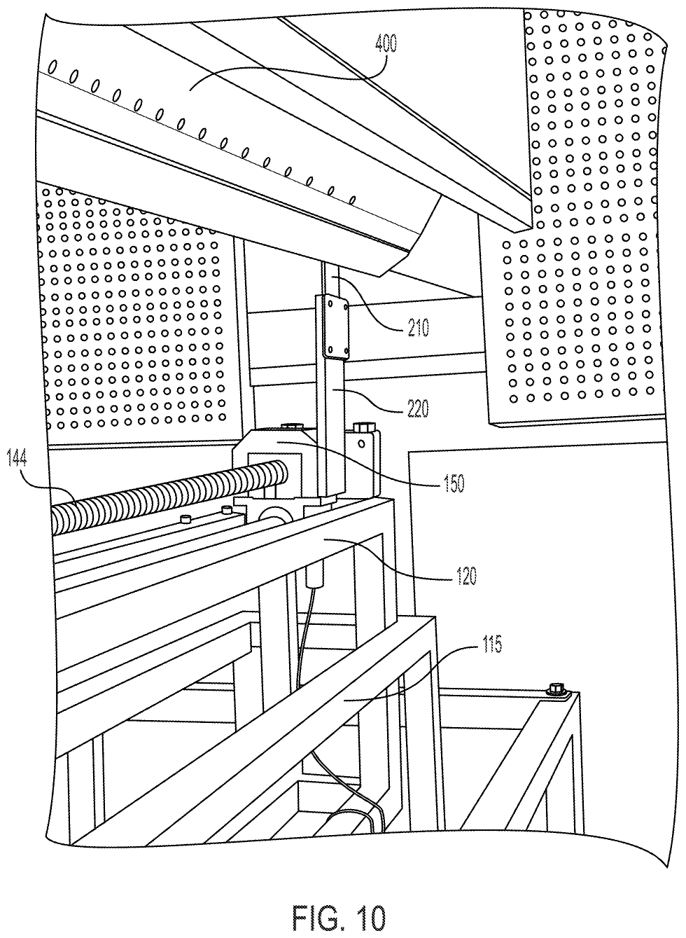

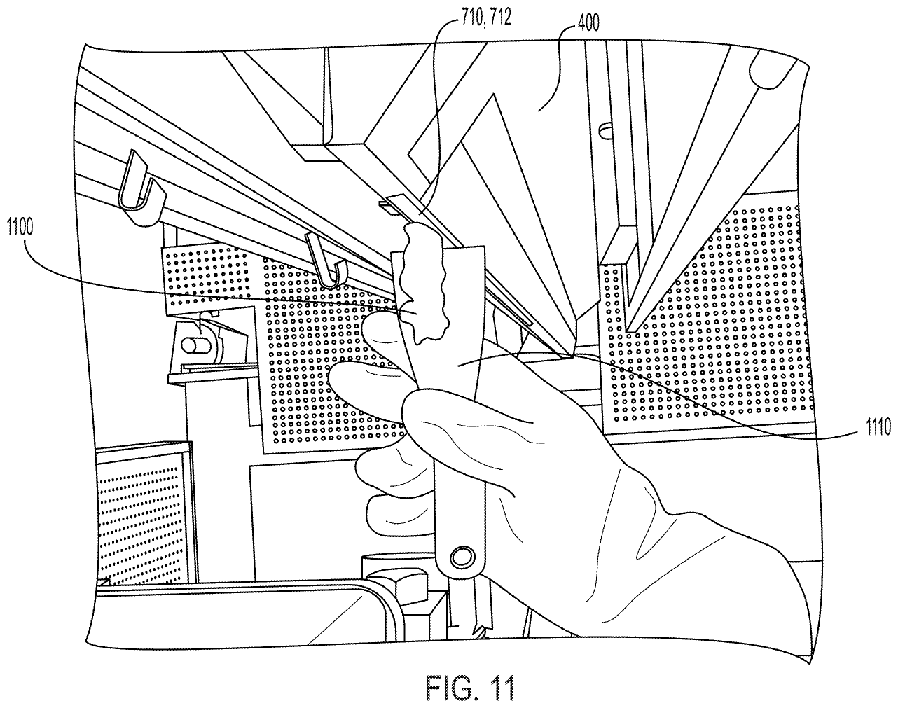

Incrementally advancing the cleaning plate 210 into the die slot 710 between passes can be advantageous because it can prevent the excess material 1100 from being pushed further up into the die slot 710 by the cleaning plate 210. FIG. 9 illustrates the lift module 120 and the cleaning plate 210 in the first intermediate position relative to the chassis 115, and FIG. 10 illustrates the lift module 120 and the cleaning plate 210 in the second intermediate position relative to the chassis 115.

In some example aspects, as shown in FIG. 11, the operator or other user can manually scrape away the excess material 1100 pushed out of the die slot 710 to prevent the excess material 1100 from accumulating at the slot opening 712 of the die slot 710. For example, a handheld scraping tool 1110 can be used to scrape the excess material 1100 away. In other aspects, the excess material 1110 pushed out of the die slot 710 can be removed by any other suitable device or technique. In some aspects, the excess material 1100 can be scraped away during or after each pass of the cleaning plate 210 (shown in FIG. 2). In other aspects, the excess material 1100 can be scraped away more frequently or less frequently as needed. In other aspects, it may not be necessary to scrape the excess material 1100 away from the slot opening 712.

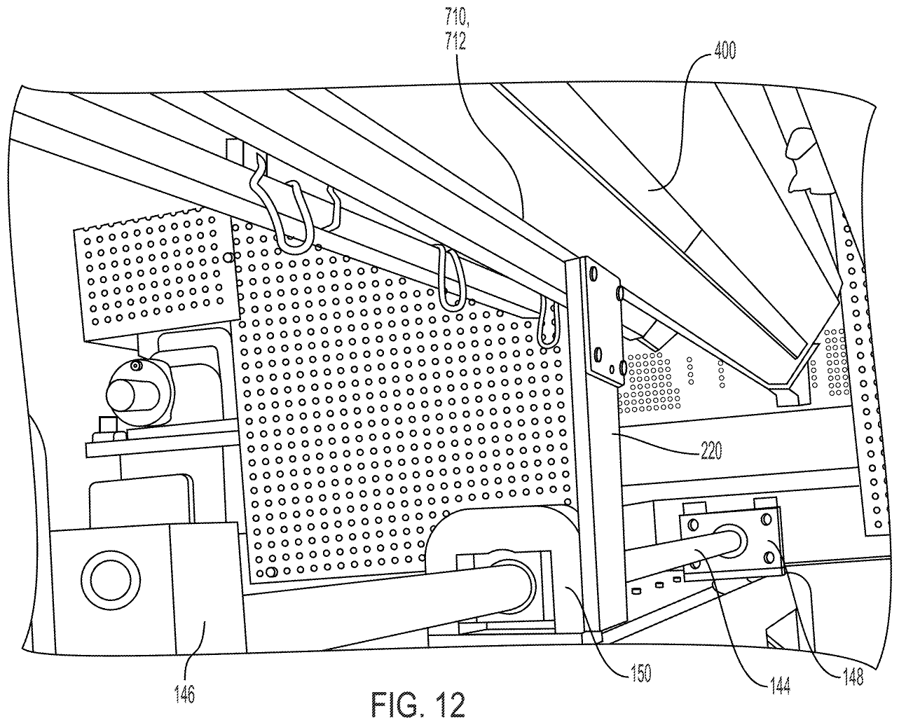

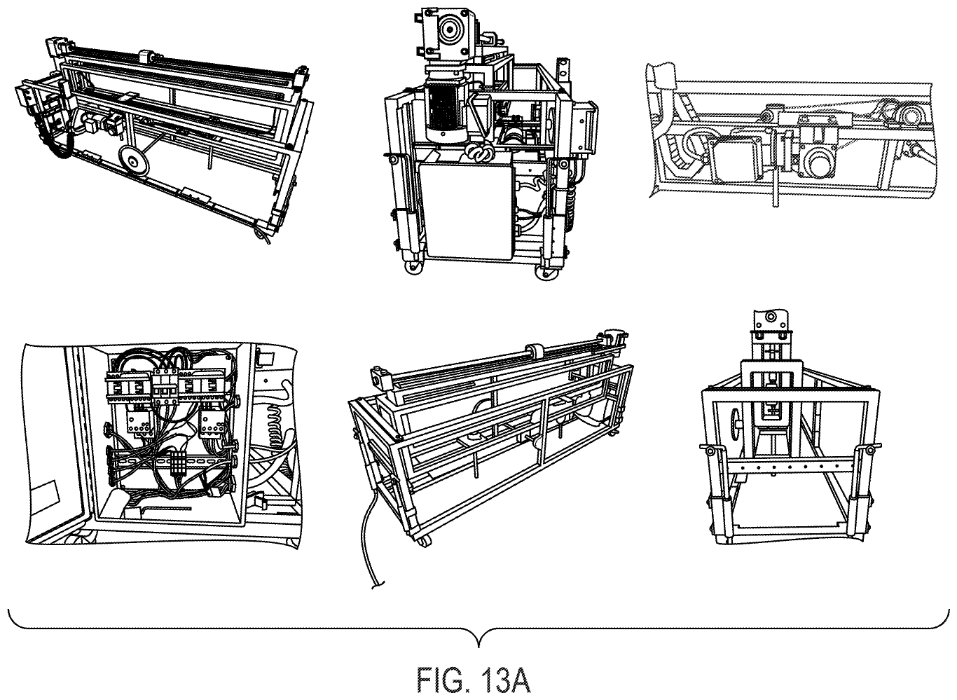

The process of incrementally raising the cleaning plate 210 within the die slot 710 between lateral passes can continue until a final lateral pass is completed with the cleaning plate 210 fully inserted into the die slot 710 in the raised position. The cleaning plate 210 can be passed across the die slot 710 in as many or as few intermediate positions as necessary before moving to the raised position. In other aspects, the cleaning plate 210 may not be oriented in any of the intermediate positions, and instead, can be fully inserted into the die slot 710 in the raised position for the first pass. Once the process is completed, any additional excess material 1100 can be scraped away by the handheld scraping tool 1110 or any other removal devices or techniques, if necessary. FIG. 12 illustrates the cleaning plate 210 (shown in FIG. 2) in the raised position.

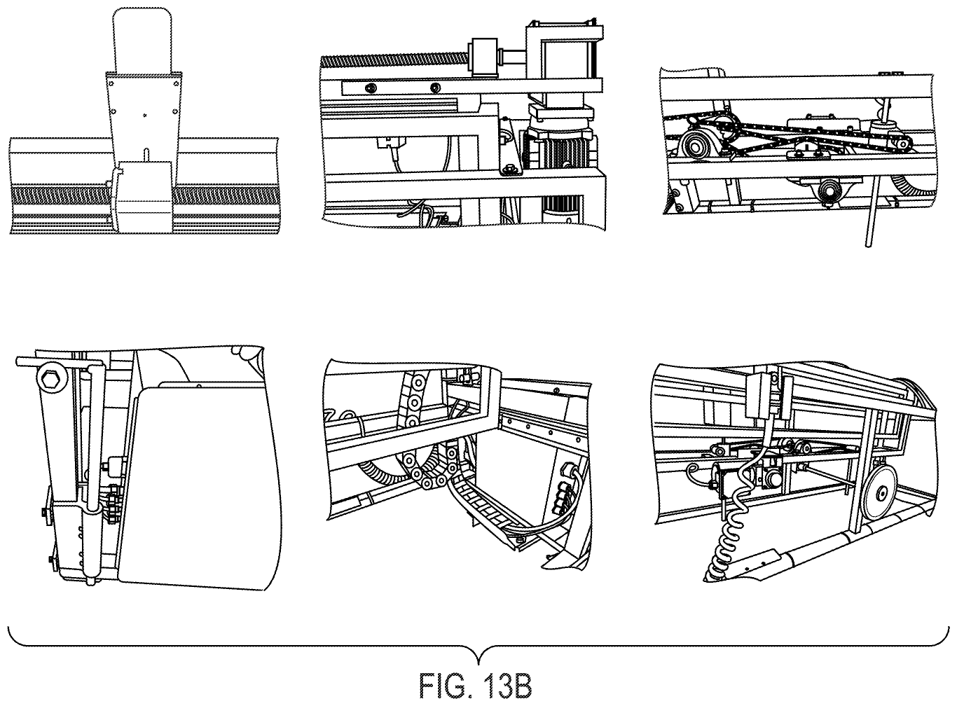

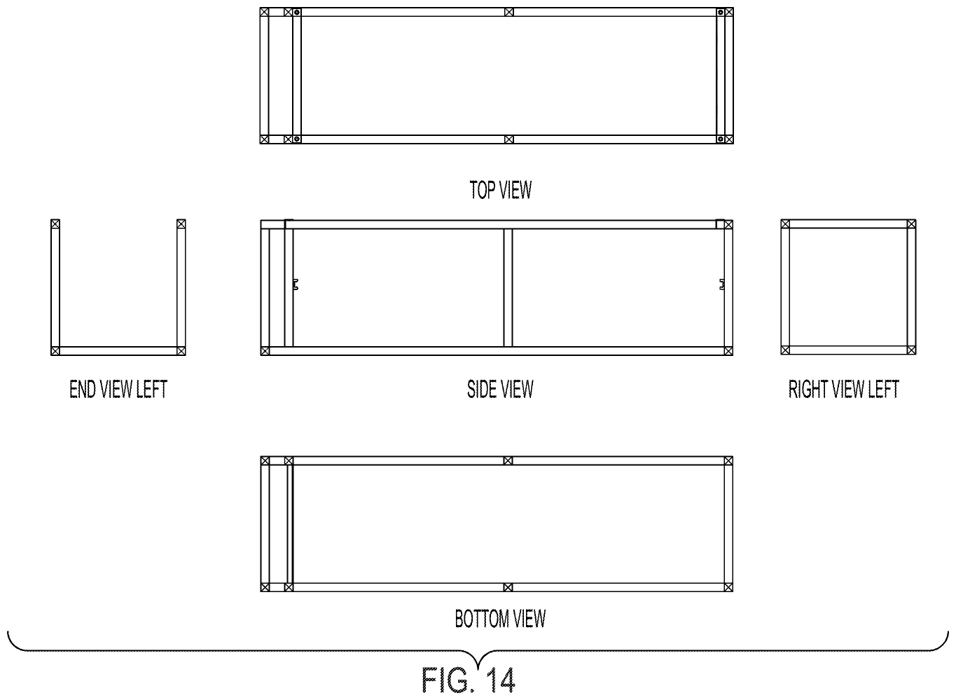

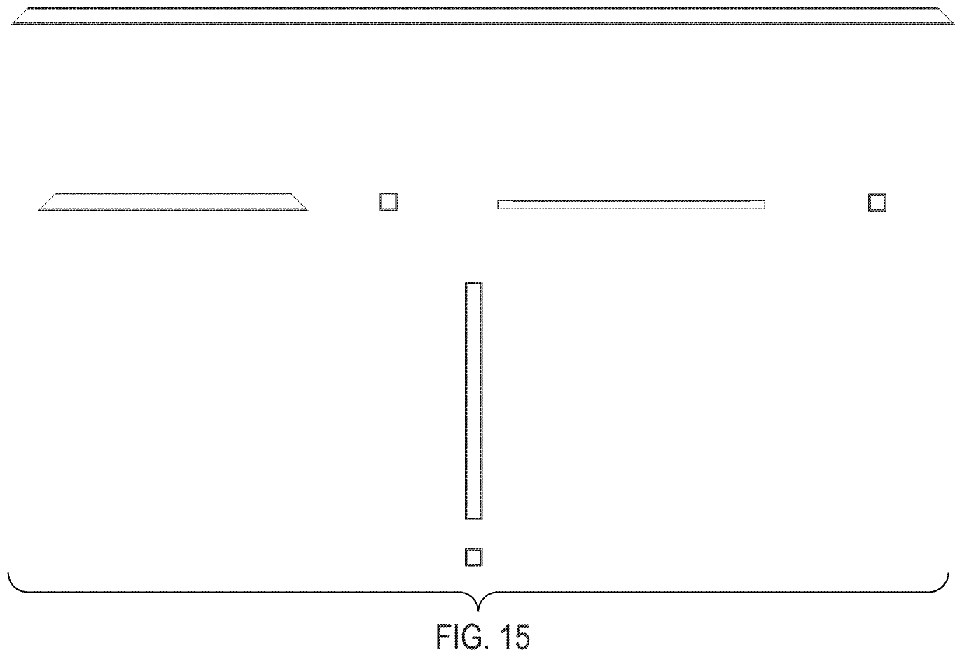

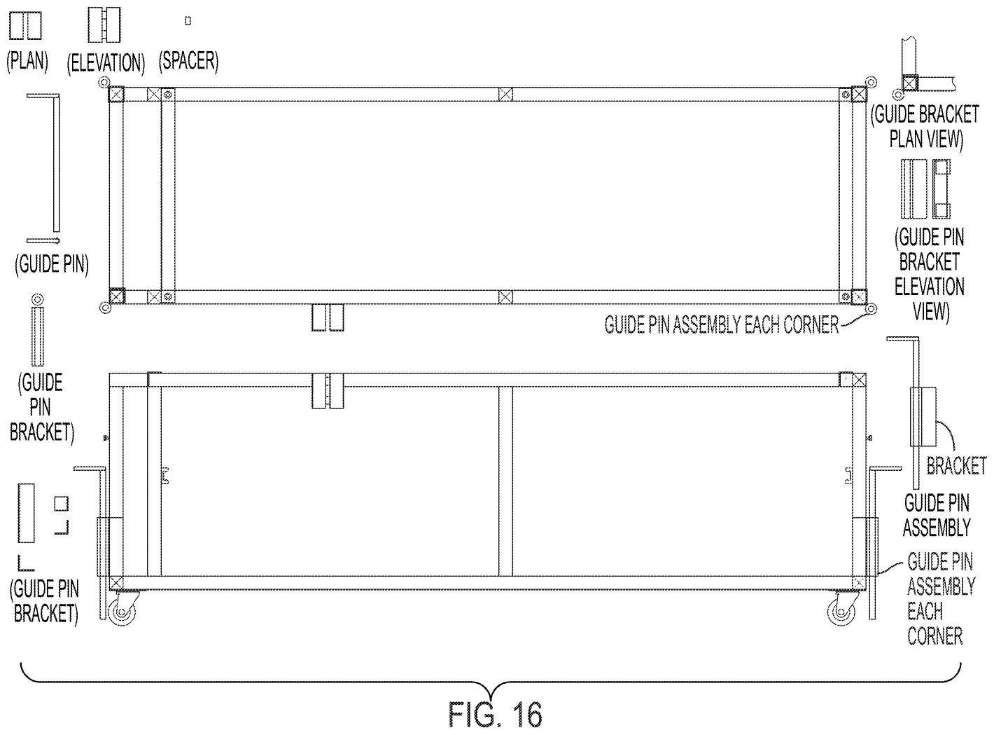

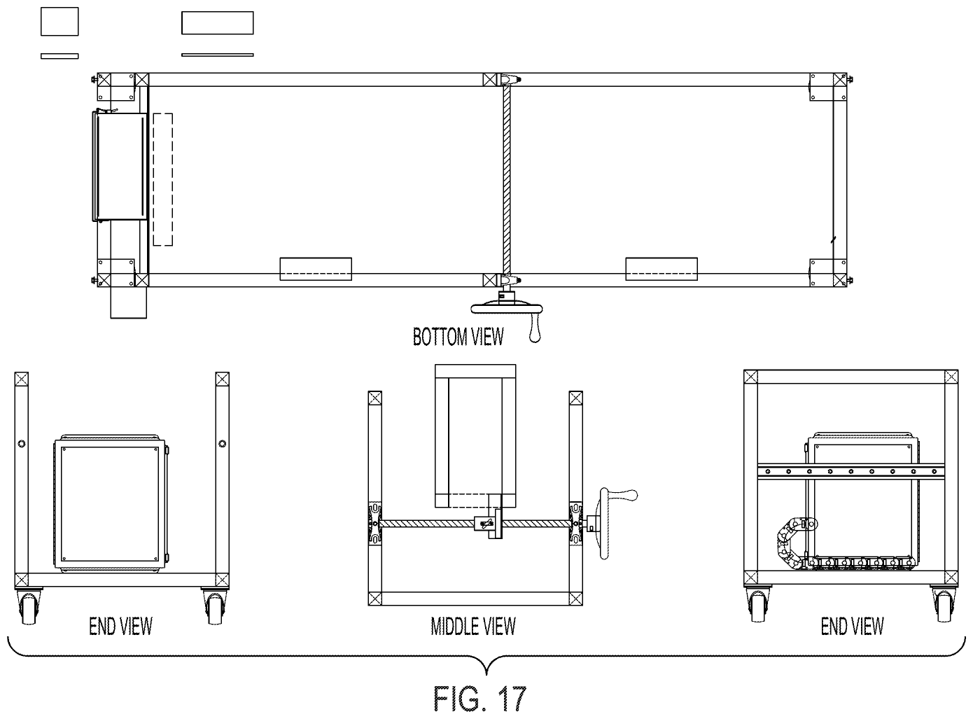

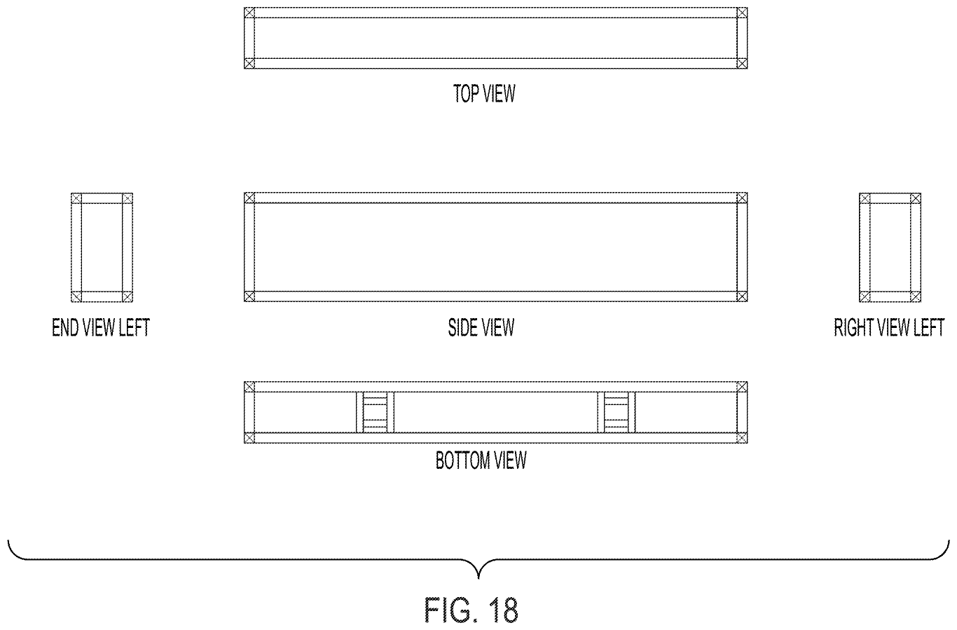

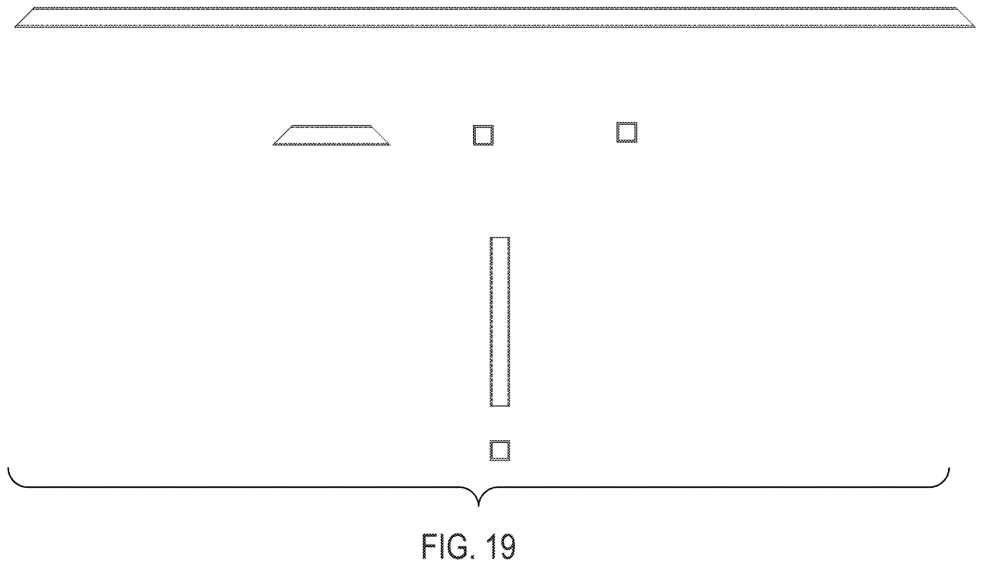

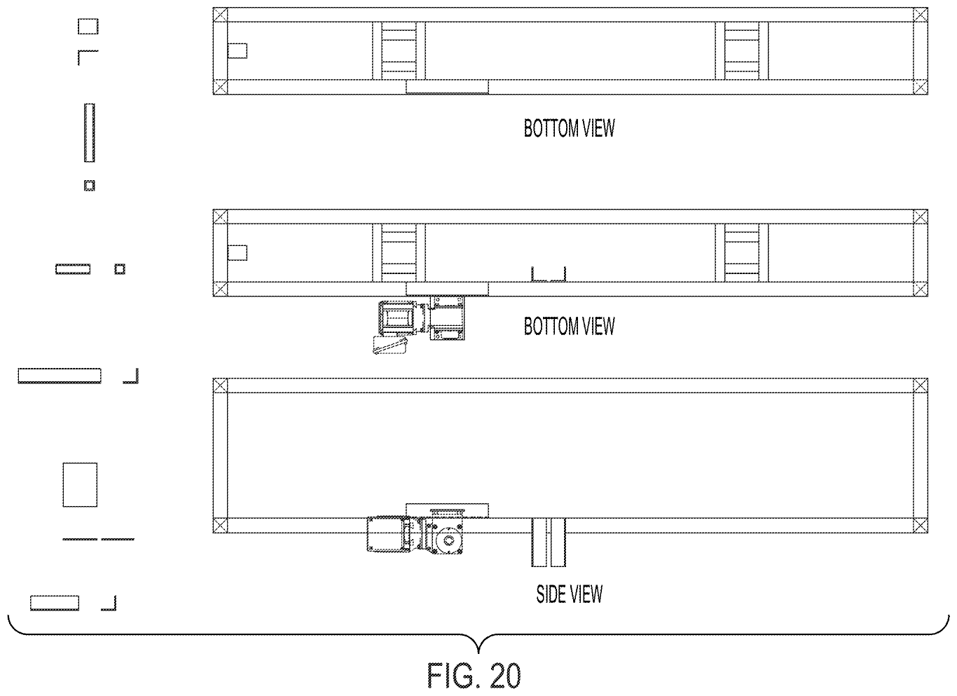

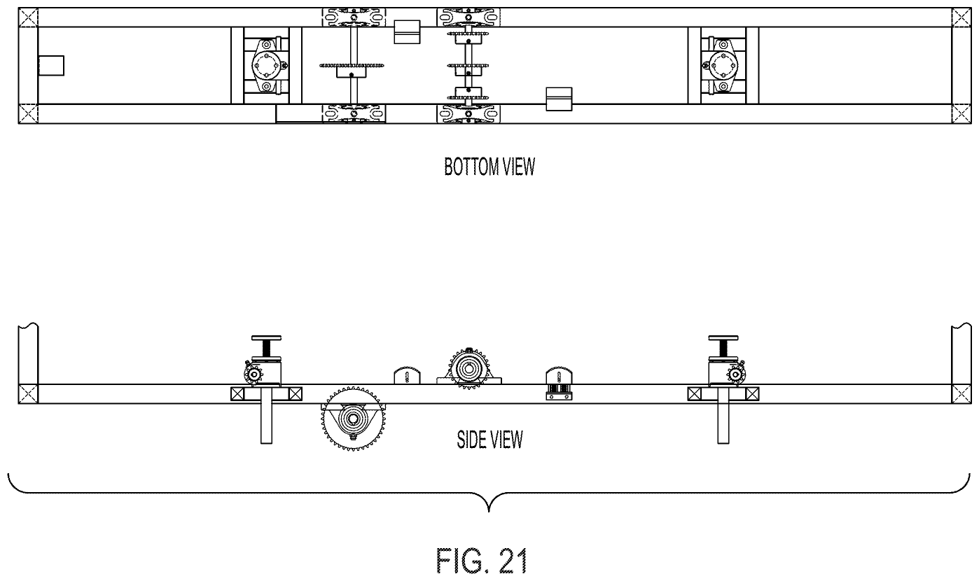

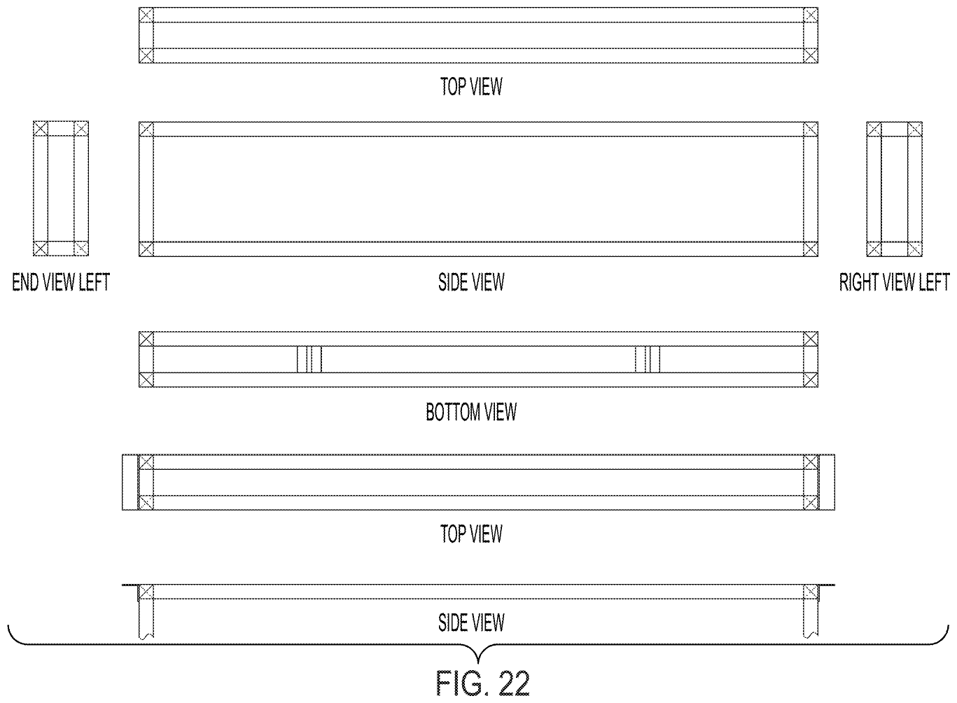

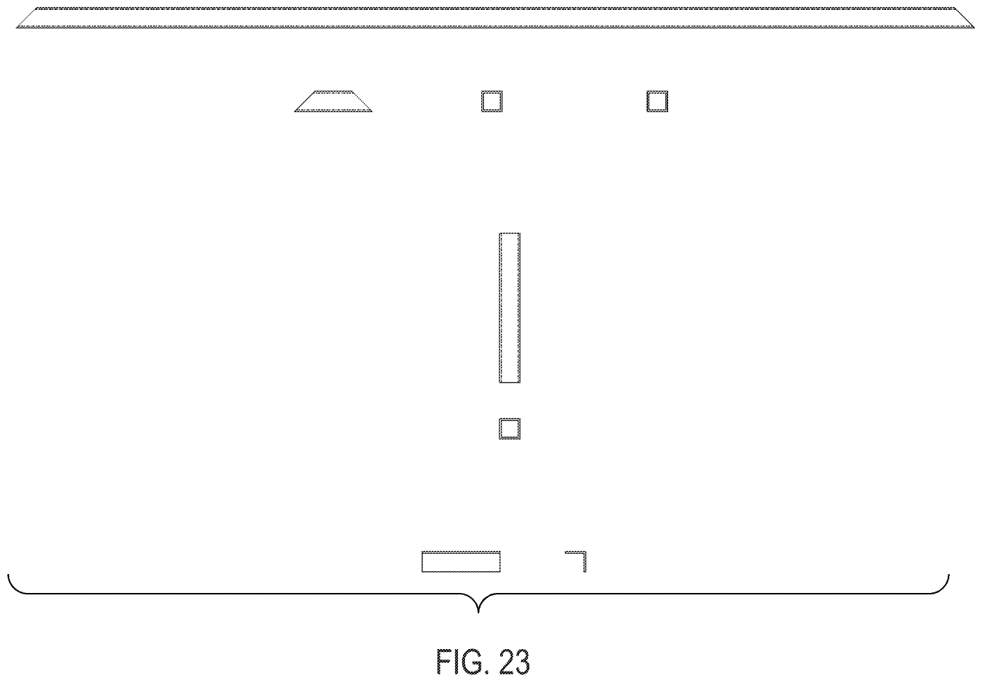

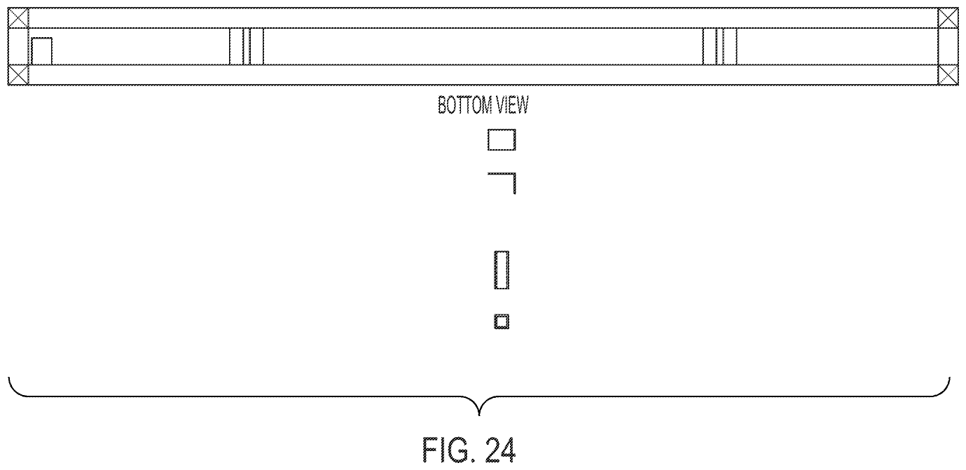

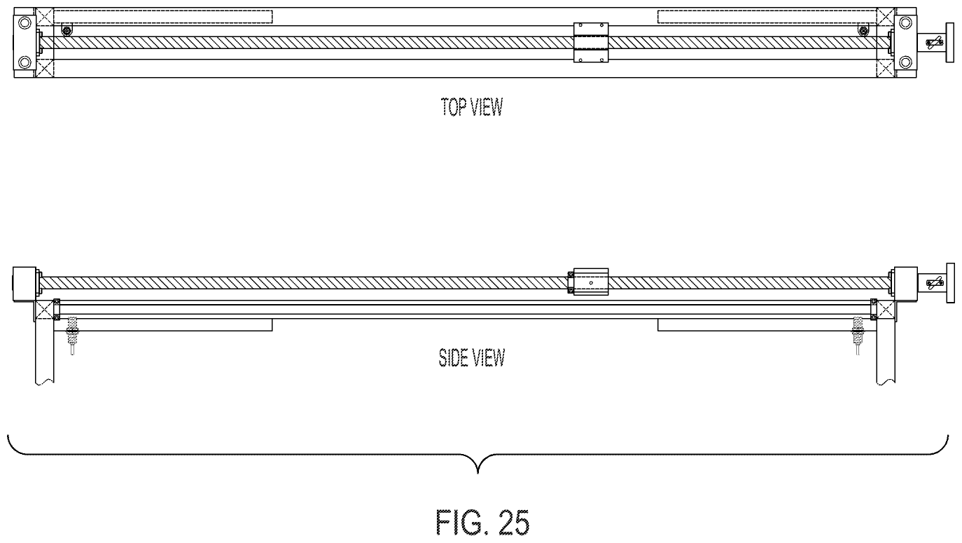

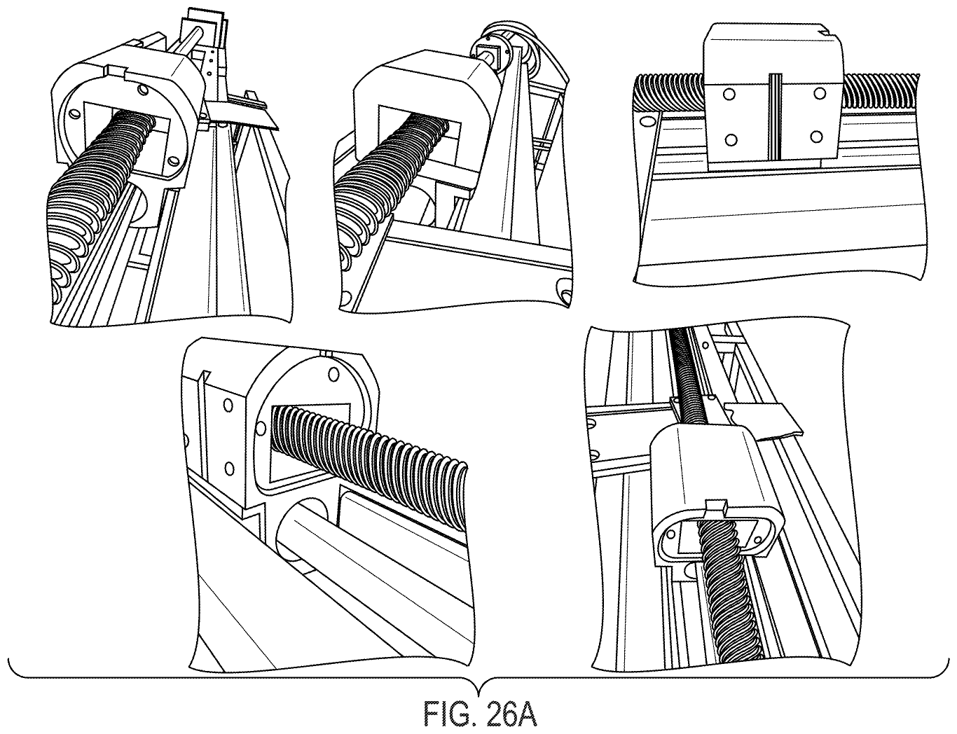

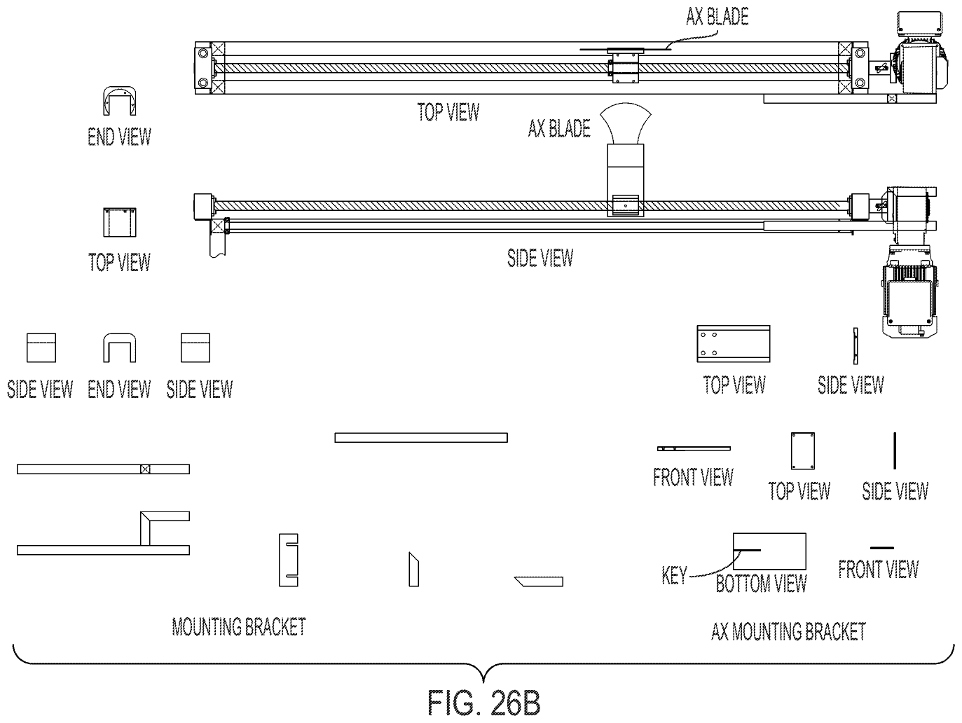

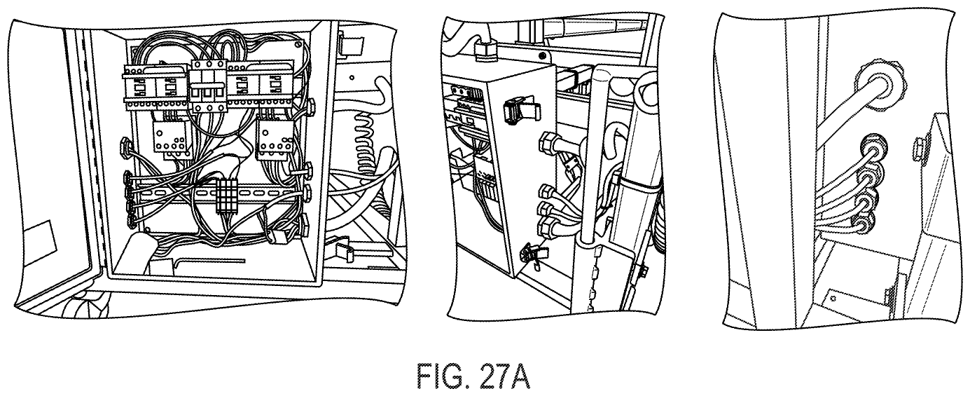

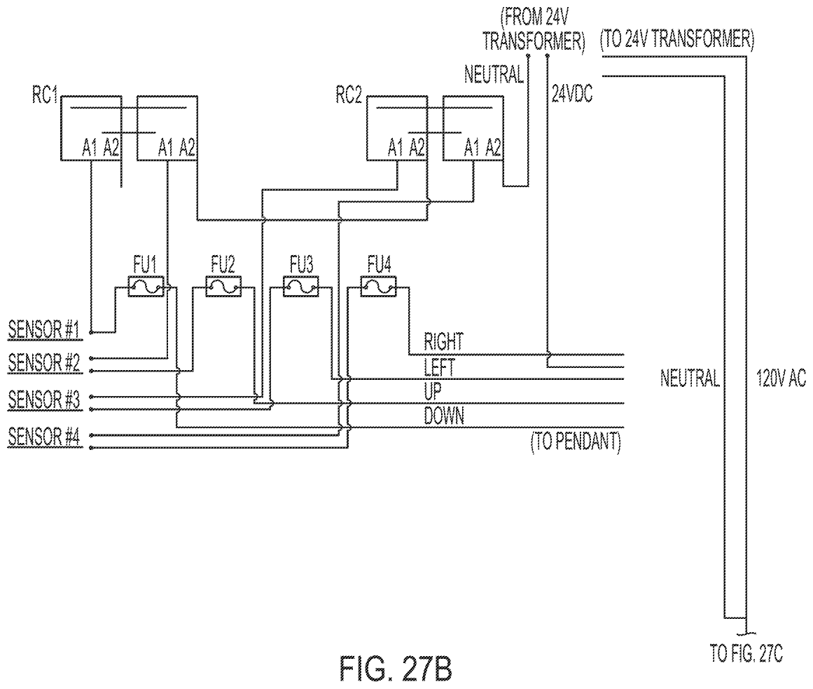

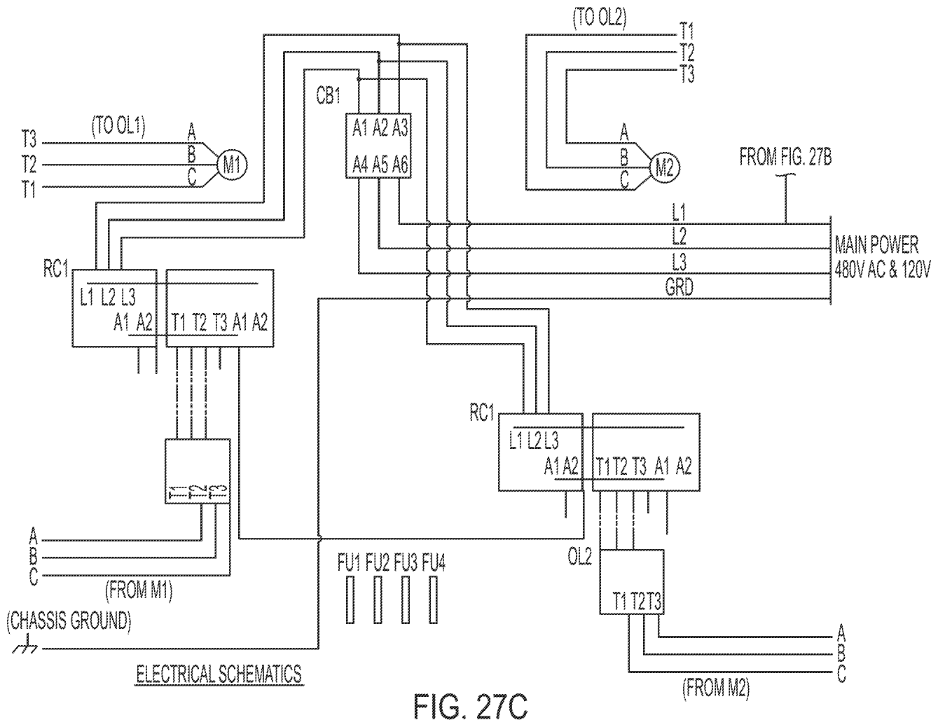

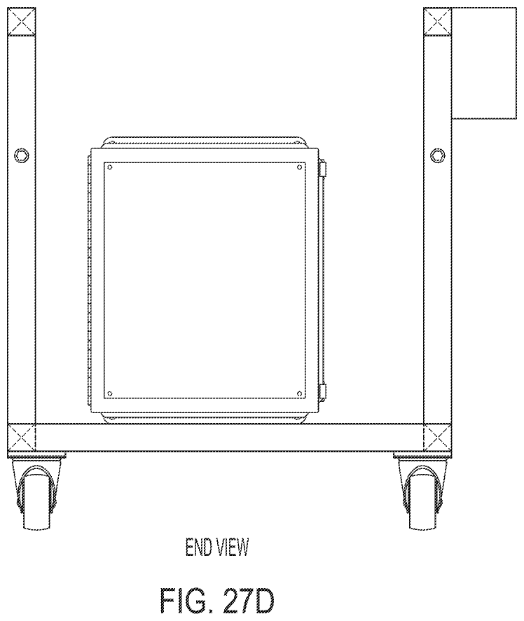

FIGS. 13A-27F illustrate additional example aspects of the die cleaning device 100.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A die cleaning device comprising:
a device body comprising a chassis;
a plate assembly movably mounted to the device body and comprising a cleaning plate, the cleaning plate configured to engage a die slot of a die and dislodge excess material trapped within the die slot;
a lift mechanism configured to move the cleaning plate relative to the chassis between at least a lowered position and a raised position, wherein, in the lowered position, the cleaning plate is disengaged from the die slot, and in the raised position, the cleaning plate engages the die slot; and
a drive mechanism configured to laterally move the cleaning plate relative to the chassis within the die slot.

2. The die cleaning device of claim 1, wherein:
the device body both further comprises a lift module movably mounted to the chassis;
the plate assembly is mounted to the lift module; and
the lift mechanism is configured to lower and raise the lift module relative to the chassis to move the cleaning plate between the lowered position and the raised position.

3. The die cleaning device of claim 2, wherein the drive mechanism is mounted to the lift module and is configured to laterally move the plate assembly relative to the lift module.

4. The die cleaning device of claim 1, wherein:
the drive mechanism is a screw drive mechanism comprising an elongate threaded screw;
the elongate threaded screw is rotationally engaged with a threaded bore of the plate assembly; and
the plate assembly is configured to translate laterally along the elongate threaded screw.

5. The die cleaning device of claim 4, wherein:
the plate assembly further comprises a plate carriage;
the plate carriage defines the threaded bore;
the cleaning plate extends substantially upward from the plate carriage; and
the cleaning plate defines a free upper plate end distal to the plate carriage and configured to engage the die slot.

6. The die cleaning device of claim 5, wherein the drive mechanism further comprises a first end block and a second end block, the elongate threaded screw extends between the first end block and the second end block, and the plate carriage is configured to translate laterally along the elongate threaded screw between the first end block and the second end block.

7. The die cleaning device of claim 6, wherein:
the elongate threaded screw rotationally engages each of the first end block and the second end block;
the drive mechanism further comprises a motor; and
the motor drives rotation of the elongate threaded screw at one of the first end block and the second end block.

8. The die cleaning device of claim 5, wherein:
the plate assembly further comprises a plate mount coupling the cleaning plate to the plate carriage;
the plate mount comprises an inner mounting plate and an outer mounting plate; and
a lower end of the cleaning plate is clamped between the inner mounting plate and the outer mounting plate.

9. The die cleaning device of claim 1, wherein the die cleaning device comprises a plurality of wheels coupled to the chassis, the plurality of wheels configured to roll across a support surface to transport the die cleaning device and to align the cleaning plate with the die slot of the die.

10. The die cleaning device of claim 9, wherein the die cleaning device further comprises a locking mechanism configured to arrest movement of the die cleaning across the support surface, and wherein the locking mechanism comprises a locking member configurable in an unlocked position and a locked position.

11. The die cleaning device of claim 10, wherein:
the locking member is a locking pin defining a lower pin end;
in the unlocked position, the locking pin is disengaged from the support surface; and
in the locked position, the lower pin end of the locking pin is configured to engage a locking hole formed in the support surface.

12. The die cleaning device of claim 11, wherein the die cleaning device comprises a pin retainer secured to the chassis, and wherein a handle portion of the locking pin is supported on the pin retainer in the unlocked position.

13. The die cleaning device of claim 1, wherein the cleaning plate is formed as a substantially planar paddle.

14. The die cleaning device of claim 1, further comprises a scraping tool configured to scrape away the excess material pushed out of the die slot by the cleaning plate.

15. The die cleaning device of claim 1, wherein:
the cleaning plate is further positionable in at least one intermediate position between the raised position and the lowered position;
in the intermediate position, a first segment of the cleaning plate is configured to engage the die slot; and
in the raised position, both of the first segment and an additional second segment of the cleaning plate are configured to engage the die slot.

16. A method of cleaning a die, the method comprising:
aligning a cleaning plate of a plate assembly of a die cleaning device with a die slot of the die, wherein the cleaning plate is in a lowered position and disengaged from the die slot;
engaging the cleaning plate with the die slot; and
sliding the cleaning plate laterally within the die slot to dislodge excess material trapped within the die slot.

17. The method of claim 16, wherein the die cleaning device comprises a plurality of wheels, and wherein aligning the cleaning plate of the die cleaning device with the die slot of the die comprises rolling the wheels across a support surface to move the die cleaning device into a suitable position relative to the die.

18. The method of claim 17, wherein:
the die cleaning device further comprises a locking mechanism configured to arrest movement of the die cleaning across the support surface;
the locking mechanism comprises a locking pin configurable in an unlocked position and a locked position; and
the method further comprises engaging a lower pin end of the locking pin with a locking hole formed in the support surface in the locked position.

19. The method of claim 16, wherein engaging the cleaning plate with the die slot comprises moving the cleaning plate from the lowered position to a raised position with a lift mechanism of the die cleaning device.

20. The method of claim 19, wherein:
the die cleaning device further comprises a screw drive mechanism comprising an elongate threaded screw;
the elongate threaded screw is rotationally engaged with a threaded bore of the plate assembly; and
sliding the cleaning plate laterally within the die slot comprises rotating the elongate threaded screw within the threaded bore to translate the plate assembly laterally along the elongate threaded screw.

21. The method of claim 19, wherein:
the cleaning plate is further positionable in at least a first intermediate position between the raised position and the lowered position;
in the first intermediate position, a first segment of the cleaning plate engages the die slot and the method comprises sliding the cleaning plate laterally within the die slot in at least a first pass; and
in the raised position, both of the first segment and an additional second segment of the cleaning plate engage the die slot and the method further comprises sliding the cleaning plate laterally within the die slot in at least a second pass.

22. The method of claim 16, further comprising scraping away the excess material dislodged by the cleaning plate with a scraping tool.
